(19) United States
(12) Patent Application Publication
(10) Pub. No.: US 2005/0022246 A1
(43) Pub. Date: Jan. 27, 2005

(54) Method of transmitting video files

(76) Inventor: Shao-Tsu Kung, Taipei (TW)

Correspondence Address: Han-Yi Lee;BAYSHORE PATENT GROUP, LLC., 520 Chantecler Dr., Fremont, CA, 94539, US

(21) Appl. No.: 10/856,582

(22) Filed: May 28, 2004

(30) Foreign Application Priority Data
Jul. 24, 2003 (TW) 092120206

(51) Int. Cl. H04N 7/173; H04N 7/10; H04N 7/025

(52) U.S. Cl. 725/90; 725/135; 725/32

(57) ABSTRACT

Disclosed is a method of transmitting video files, wherein an electronic device performs the steps of: (a) receiving a first video segment from time T₀ to time T₀+ΔT within a video file transmitted via a network from a video server; (b) receiving plural nₜₕ video segments from time Tₙ to time Tₙ+ΔTT within the video file transmitted via the network from the video server, wherein n=1, 2, 3, . . . N, and N is the number of video skipping points, ΔT and ΔTT are predetermined playback length, and time T₀<time T₁<time T₂<time T₃< . . . <time Tₙ; (c) playing the first video segment; (d) detecting whether a skip playback command has been received while the electronic device playing the first video segment, if affirmative, the electronic device skips to play the nₜₕ video segment, and subjecting the time T₀ of the video server to be time Tₙ, if negative, the electronic device continues playing the first video segment until the time T0+ΔT, and subjecting the time T₀ of the video server to be time T₀+ΔT, in which the skip playback command serves to instruct the electronic device to play the nₜₕ video segment; and (e) repeating steps (a) to (d) until the end of the video file.

### FIELD OF THE INVENTION

This invention relates to a method of transmitting video files via a network, particularly to one capable of eliminating the wasting of network resources while downloading video files via a network and allowing the video file to be played in a skipping manner until a viewer stops the skipping operation.

### BACKGROUND OF THE PRIOR ART

A conventional method of transmitting video files via a network is shown in FIG. 1, in which a media player first prefetches parts of a video file, and then starts playing the video file 10 while displaying the current playback time 10b within the video file 10. At the same time that the media player plays the content of the video file 10 that has been downloaded, the media player downloads the remaining content of the video file 10 until the entire video file 10 has been downloaded. During the playback period of the media player, the viewer may also move the playback time 10b to instruct the media player progressing to a designated playback time 10b for direct playback while the media player continues downloading the content of the video file 10 subsequent to the playback time 10b until the entire video file 10 has been downloaded. Such conventional art, however, involves the following shortcomings, (1) when a viewer aborts the current video file 10 under viewing, or moves the playback time 10b, the portion of the video file 10 that has already been downloaded by the media player for later playback is considered wasted, thereby squandering network resources; and (2) since the media player can only play the content of the video file that has already been downloaded, unless downloading is performed upon moving the playback time 10b, the viewer cannot view the content of the video file immediately upon moving the playback time 10b, thereby wasting even more network resources in the operation of searching the content of the video file.

In view of the shortcomings of the prior art, the inventor of this invention made improvements and invented a method that is completely different from the prior art, which allows the viewer to directly play the video file in a skipping manner when he no longer wishes to view the current video, or intends to search for certain content within the video file that he is interested in, until the viewer stops the skipping operation, thereby eliminating the problem of wasting network resources while downloading video files via a network.

### SUMMARY OF THE INVENTION

It is a primary objective of this invention to provide a video file that is capable of eliminating the problem of wasting network resources while downloading video files via a network.

It is another objective of this invention to provide a method of downloading video files without squandering network resources, which allows a viewer to operate an electronic device and to directly play the video file in a skipping manner when he no longer wishes to view the current video, or intends to search for certain content within the video file that he is interested in, until the viewer stops the skipping operation, while viewing a video file by means of the electronic device.

To achieve the above objectives of this invention, this invention provides a method of transmitting video files, wherein an electronic device performs the steps of: (a) receiving a first video segment from time T₀ to time T₀+ΔT within a video file transmitted via a network from a video server; (b) receiving plural nₜₕ video segments from time Tₙ to time Tₙ+ΔTT within the video file transmitted via the network from the video server, wherein n=1, 2, 3 . . . N, and N is the number of video skipping points, ΔT and ΔTT are predetermined playback length, and time T₀<time T₁<time T₂<time T₃< . . . <time Tₙ; (c) playing the first video segment; (d) detecting whether a skip playback command has been received while the electronic device playing the first video segment, if affirmative, the electronic device skips to play the nₜₕ video segment, and subjecting the time T₀ of the video server to be time Tₙ, if negative, the electronic device continues playing the first video segment until the time T₀+ΔT, and subjecting the time T₀ of the video server to be time T₀+ΔT, in which the skip playback command serves to instruct the electronic device to play the nₜₕ video segment; and (e) repeating steps (a) to (d) until the end of the video file.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 illustrates a conventional method of transmitting video files via a network;

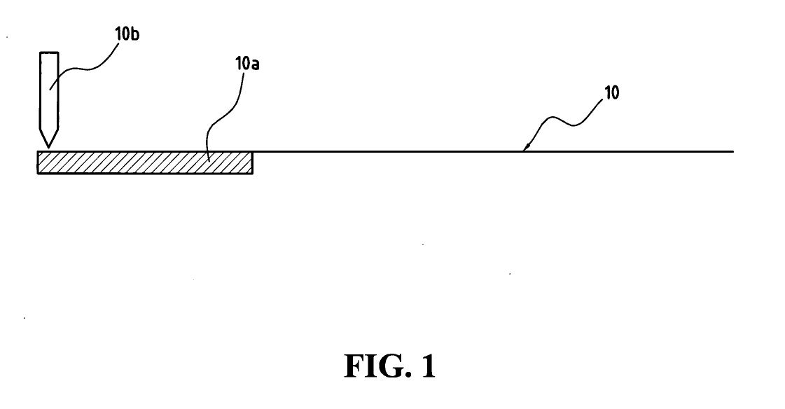

FIG. 2 illustrates a schematic view of a hardware environment according to the method of this invention;

FIG. 3 illustrates a flowchart according to the method of this invention; and

FIGS. 4A to 4C illustrates the state of a video file transmitted by the method of this invention.

### DETAILED DESCRIPTION OF THE INVENTION

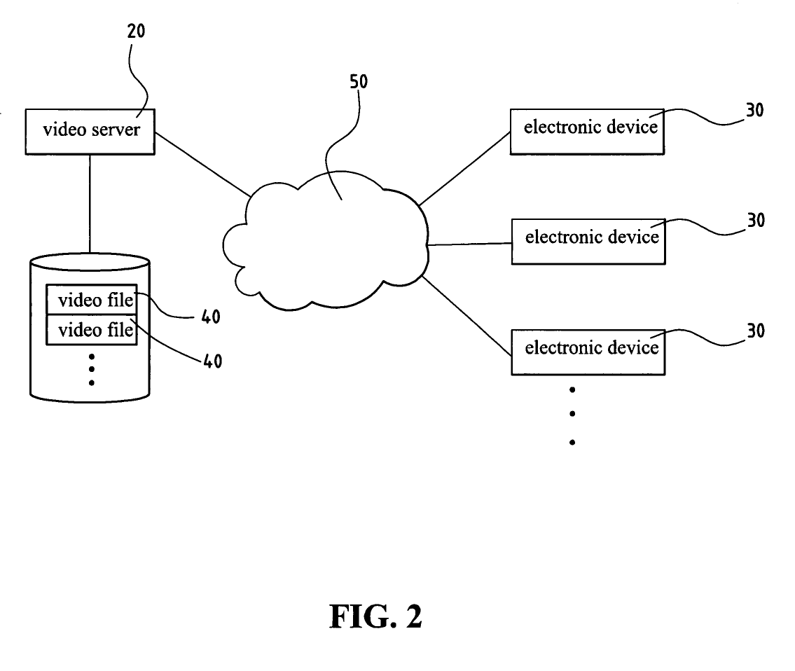

FIG. 2 illustrates a schematic view of a hardware environment according to the method of this invention. A video server 20 is stored therein with plural video files 40 to be downloaded via a network 50 and viewed by an electronic device 30. This invention allows a viewer to directly play a video file 40 by means of an electronic device 30 in a skipping manner when he no longer wishes to view the current video, or intends to search for certain content within the video file that he is interested in, until the viewer stops the skipping operation. An actual example of the electronic device 30 implementing this invention may be a mobile phone, a PDA, or a computer; that of the network 50 may be a web network, a local network, or a mobile digital communication network implemented in mobile electronic devices, such as GPRS.

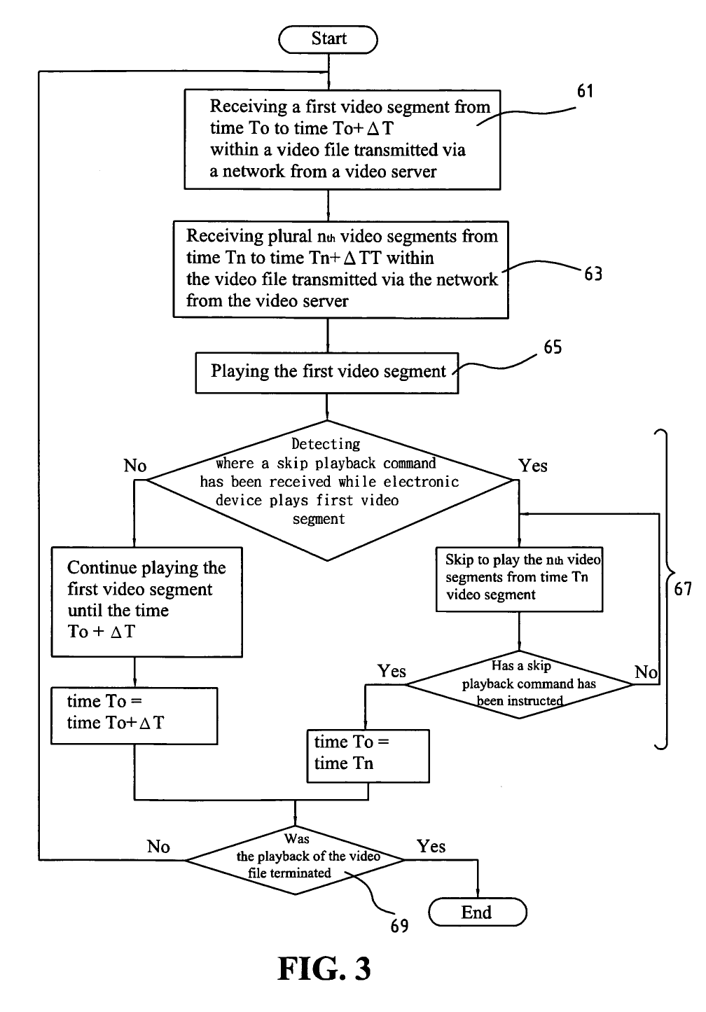

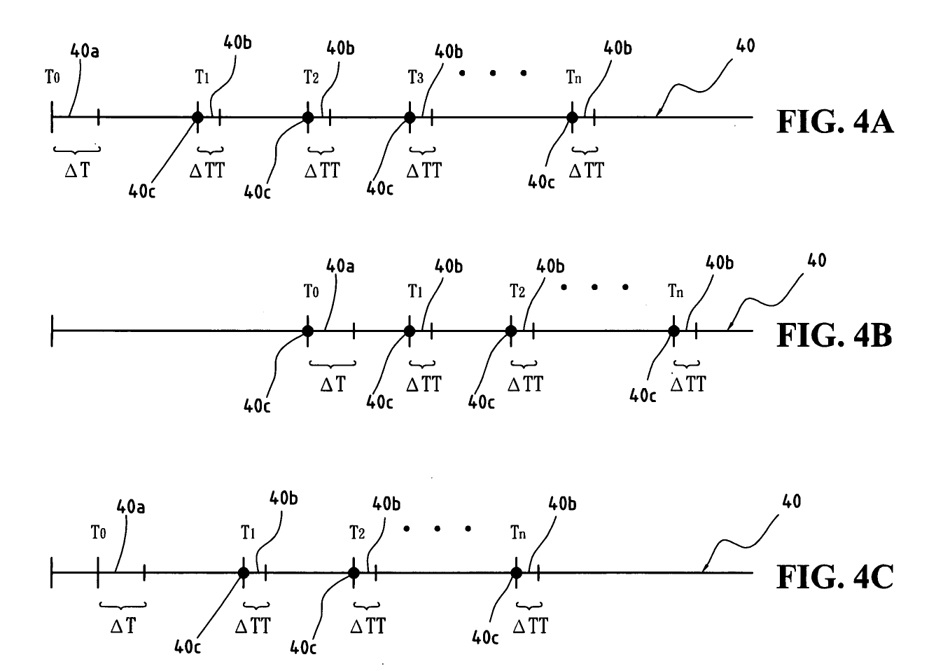

FIG. 3 illustrates a flowchart according to the method of this invention. According to the method of transmitting video files of this invention, an electronic device 30 performs the steps of: (61) receiving a first video segment 40a from time T₀ to time T₀+ΔT within a video file 40 transmitted via a network 50 from a video server 20; (63) receiving plural nₜₕ video segments 40b from time Tₙ to time Tₙ+ΔTT within the video file 40 transmitted via the network 50 from the video server 20, wherein n=1, 2, 3, . . . , N, and N is the number of video skipping points 40c, ΔT and ΔTT are predetermined playback length, and time T₀<time T₁<time T₂<time T₃< . . . <time Tₙ. With reference to FIGS. 4A and 4C, which illustrate the state of a video file transmitted by the method of this invention, as shown in FIG. 4A, the video server 20 first transmits the first video segment 40a of the time T₀ to time T₀+ΔT within the video file 40 to the electronic device 30. Then, the video server 20 transmits plural nₜₕ video segment 40b the time Tₙ to time Tₙ+ΔTT within the video file 40 to the electronic device 30. After completing steps (61) and (63), the content of the video file 40 received by the electronic device 30 would include the first video segment 40a and the plural nₜₕ video segment 40b. The time T₀ and time Tₙ, in actual implementation, may be in terms of the segment size or the playback time of the video file 40. The number of the video skipping points 40c, in actual implementation, may be determined by the size of the buffer of the electronic device 30 for temporarily storing the content of the video files 40 as received, or be reconfigured in accordance with the actual state of transmission.

The electronic device 30 then continues with the steps of: (65) playing the first video segment 40a; (67) detecting whether a skip playback command has been received while the electronic device 30 playing the first video segment 40a, if affirmative, the electronic device 30 skips to play the nₜₕ video segment 40b, and subjecting the time T₀ of the video server 20 to be time Tₙ upon the view has determined the skipping point, if negative, the electronic device 30 continues playing the first video segment 40a until the time T₀+ΔT, and subjecting the time T₀ of the video server to be time T₀+ΔT, in which the skip playback command serves to instruct the electronic device 30 to play the nₜₕ video segment 40b. In steps (65) and (67) the viewer views the first video segment 40a played by the electronic device 30. If the viewer no longer wishes to view the first video segment 40a, the viewer will operate the electronic 30 and instruct a skip playback command, such as by pressing a button of the electronic device 30 to instruct the skip playback command. The electronic device 30 is able to comprehend which of the video skipping points 40c that the viewer intends to skip to, based on the number of the viewer pressing the button. Then, the electronic device 30 would play the nₜₕ video segment 40b based on the video skipping point 40c as finally selected by the user. Every time the viewer presses the button, the viewer is able to view the nₜₕ video segment 40b at the video skipping point 40c. After the view has selected a skipping point, the electronic device 30 would subject the time T₀ of the video server 20 to be time Tₙ. With reference to FIG. 4B, the video server 20 then transmits the video segments following the nₜₕ video segment 40b and the succeeding time. If the viewer did not instruct any skip playback command while viewing the first video segment 40a, the electronic device 30 would continue playing the first video segment 40a until the time T₀+ΔT, and subjecting the time T₀ of the video server 20 to be time T₀+ΔT, as shown in FIG. 4C.

The electronic device 30 then continues with the step of: (69) repeating steps (61) to (67) until the end of the video file 40.

Using the segment size of the video file 40 as a coordinate as an example to explain the playback time of this invention, the Time T₀ is a time representing the file size of the video file 40 to be played, and the subsequent Time T₁, Time T₂, Time T₃, . . . , Time Tₙ can all be the next playback time that the view intends to skip to, and each represents the various segment sizes of the video file. This invention allows the user to operate, preview and change the content of the video segments to be played based on the file size of the video file 40, to determine whether the playback time is in fact desired.

Using the playback time of the video file 40 as a coordinate as an example to explain the playback time of this invention, the time T₀ is a time representing the playback time of the video file 40 to be played, and the subsequent time T₁, time T₂, time T₃ . . . time Tₙ can all be the next playback time that the view intends to skip to, and each represents the various playback time of the video file 40. This invention allows the user to operate, preview and change the content of the video segments to be played based on the playback time of the video file 40, to determine whether the playback time is in fact desired.

According to this invention, the size of the predetermined parameters of playback length, including ΔT and ΔTT, may be determined by the size of the buffer of the electronic device 30 for establishing an appropriate playback length. By using the parameter ΔTT, this invention allows the user to immediately view the video segment of the playback length between the time Tₙ and time Tₙ+ΔTT upon skipping. By using the parameter ΔT, the first video segment 40a is only downloaded and played for a playback length of ΔT playback length, thereby eliminating the problem of squandering the network resources.

The video files 40 implemented in this invention may cover any video formats that may be processed and played by bit stream technology, or any other formats that may be played after being downloaded via a network.

Further, the method of this invention may be implemented in media players, to allow an electronic device 30 equipped with a media player to perform this invention, so as to demonstrate the features and effects of this invention.

The present invention has been described with a preferred embodiment thereof and it is understood that the scope and the spirit of the invention as defined by the appended claims.

1. A method of transmitting video files, wherein the method is performed by an electronic device, the method comprising:
(a) receiving a first video segment from time T₀ to time T₀+ΔT within a video file transmitted via a network from a video server;
(b) receiving plural nₜₕ video segments from time Tn to time Tₙ+ΔTT within the video file transmitted via the network from the video server, wherein n=1, 2, 3, . . . , N, and N is the number of video skipping points, ΔT and ΔTT are predetermined playback length, and time T₀<time T₁<time T₂<time T₃< . . . <time Tₙ;
(c) playing the first video segment;
(d) detecting whether a skip playback command has been received while the electronic device playing the first video segment, if affirmative, the electronic device skips to play the nₜₕ video segment, and subjecting the time T₀ of the video server to be time Tₙ, if negative, the electronic device continues playing the first video segment until the time T₀+ΔT, and subjecting the time T₀ of the video server to be time T₀+ΔT, in which the skip playback command serves to instruct the electronic device to play the nₜₕ video segment; and
(e) repeating steps (a) to (d) until the end of the video file.

2. The method of claim 1, wherein the time T₀ and the time Tₙ represent the file size of the video file.

3. The method of claim 1, wherein the time T₀ and the time Tₙ represent the playback time of the video file.

4. The method of claim 1, wherein the electronic device is a client terminal.

5. The method of claim 1, wherein the number of the video skipping points is a predetermined number.

6. The method of claim 1, wherein the number of the video skipping points may be reconfigured.

7. The method of claim 1, wherein the electronic device is a mobile phone.

8. The method of claim 1, wherein the electronic device is a computer.

9. The method of claim 1, wherein the electronic device is a PDA.

10. The method of claim 1, wherein the network is a web network.

11. The method of claim 1, wherein the network is a local network.

12. The method of claim 1, wherein the network is a mobile digital communication network.
